(19) United States
(12) Patent Application Publication
(10) Pub. No.: US 2006/0084705 A1
(43) Pub. Date: Apr. 20, 2006

(54) Phase transfer of nanoparticles

(76) Inventors: Frank Caruso, Golm/Potsdam (DE); David Gittins, Moreton (GB)

Correspondence Address: OSTROLENK FABER GERB & SOFFEN, 1180 AVENUE OF THE AMERICAS, NEW YORK, NY, 100368403, US

(21) Appl. No.: 10/432,942

(22) PCT Filed: Nov. 23, 2001
(86) PCT No.: PCT/DE01/04401

§ 371 Date: May 27, 2003

(30) Foreign Application Priority Data
Nov. 24, 2000 (DE) 100 58 544.2
Jul. 10, 2001 (DE) 1010 32 564.9
Jul. 27, 2001 (DE) 1010 36 583.7

(51) Int. Cl. C09K 3/00

(52) U.S. Cl. 516/20

(57) ABSTRACT

The invention relates to phase transfers of nanoparticles and to a catalysis using said nanoparticles. The aim of the invention is to facilitate a transfer of nanoparticles from an organic solution to an inorganic, especially, aqueous solution. To this end, a generically describable substance class, for example the commercially available 4-dimethylaminopyridine (DMAP), which is for example dissolved in water, is added to the organic solution in sufficient amounts. This measure has the effect that the nanoparticles are readily transferred in a one-step process from the organic phase (in each case in the top section) to the inorganic phase (in each case in the lower section) in the sample container.

### PRIOR ART

The present invention relates to phase transfers of colloids, in particular of nanoparticles, and both homogeneous and heterogeneous catalysis using nanoparticles.

The widespread use of colloids and in particular very small colloids, namely nanoparticles, in the fields of biotechnology, nanotechnology, colloid and surface science, in catalysis, electronics, solid state physics and materials science at present occupies a central position in current research and development. In the following, the term “colloid” is used synonymously with the term “nanoparticle”, since the latter are merely the particular case of very small colloids. The present invention can be applied at least to colloids in the size range from 1000 nanometers to 0.1 nanometers. However, the respective, specific uses of the colloids often require specific sizes, for example relatively small sizes, if the particles are to be sprayed as colloid through narrow nozzles.

Synthetic organic preparative methods can be used in a known manner for producing nanoparticulate materials of desired morphology, size and shape in relatively high concentrations which appear suitable for many applications and for transport of the nanoparticles.

However, a large proportion of the applications of these particles requires them to be present in aqueous medium, i.e. in aqueous solution or in solutions which are miscible with water, e.g. alcohols.

A direct synthesis in water leads, however, only to low concentrations of the nanoparticles, since they precipitate at relatively high concentrations. In particular, such a direct synthesis suffers from problems due, firstly, to the occurrence of ionic interactions. These problems are usually overcome by means of low reactant concentrations, e.g. 5×10⁻⁴ M, cf. J. Turkevich, P. C. Stevensen, J. Hillier, Diskuss. Faraday Society. 1951, SS. Secondly, it can be difficult for the stabilizers required for the synthesis to be removed later. In contrast, such particles can be prepared in organic solvents at relatively high concentrations up to 1M in respect of the starting material with predictable size and shape. This is disclosed, for example, in: M. Green, P. Obrian, Chem. Commun. 1999, 2235, or in: M. P. Pileni, New J. Chem. 1998, 22, 693. These particles also display an improved monodispersity compared to those which have been synthesized in aqueous solutions. However, they are not miscible with water, which restricts their uses.

Dissolved nanoparticles are, however, necessary for many applications, since in coagulated form they lose not only their ability to be readily applied to substrates but also many of their advantageous chemical and physical properties.

A high concentration of the nanoparticles in the solution is specifically preferred for many reasons, depending on the field of application. A general advantage of a high concentration is that the solution having a high concentration of nanoparticles has only a low weight for transport compared to a solution having a low concentration.

The abovementioned relationship suggests the desirability of synthesizing colloids or nanoparticles in an organic solvent and subsequently transferring them into an aqueous or similarly useable solution. In this case, a phase transfer takes place between the organic starting solution into an essentially inorganic target solution, in particular an aqueous target solution. Such a phase transfer process has been disclosed in both directions in Liu, H., Toshima, N.: “Transferring Colloidal Metal Particles from an Organic To an Aqueous Medium and vice versa by Ligand Coordination”, Journal of the Chemical Society, Chemical Communications, Number 16, 1992, pp. 1095 to 1096. This publication teaches coating the nanoparticles covalently with sodium diphenylphosphinobenzenesulfonate (DPPS), a water-soluble phosphine ligand. Such covalent bonding is, for the purposes of the present invention, designated as “irreversible” since it can be broken again only with difficulty.

However, this covalent bonding permanently alters the chemistry of the particle surface as a result of the strong bond between ligand and nanoparticle. Furthermore, the possible applications for such DPPS-coated nanoparticles are limited, since the DPPS molecules are undesirable as an outer shell for many applications. However, the DPPS ligands can be removed again from the nanoparticle surface only with great difficulty. In addition, the maximum concentration of nanoparticles in the target solution which is obtainable in good yield in the single-step phase transfer is relatively low, since a good transfer yield can only be achieved at a fixed DPPS concentration in the aqueous solution which is optimal for the “Liu process”. These are disadvantages which cannot be accepted, or are difficult to accept, for many applications for the nanoparticles.

It would therefore be particularly desirable to be able to obtain concentrations of the nanoparticles in aqueous solution which are of similar magnitude to the concentrations in the synthesis of the nanoparticles in organic solution, if possible without being restricted in terms of the future use of the nanoparticles.

### ADVANTAGES OF THE INVENTION

A first main aspect disclosed by the present invention is the use of a substance for transferring inorganic colloids, in particular nanoparticles, from an organic starting solution into a target solution, where the target solution is either an inorganic, in particular aqueous, solution or an inorganic solution comprising water-soluble compounds, in particular alcohols, in a concentration of from 0% to 100%, where the substance comprises:

a.) at least one constituent Y (12) which can bind chemically to the surface of the colloids,

b.) at least one constituent X (16) which chemically changes the surface properties of the colloids so that phase transfer of the colloids from the organic solution into the inorganic solution is effected, and

c.) at least one spacer constituent Z (14) which is able to link at least the constituent Y (12) and the constituent X (16) and has a molecular size which is sufficiently large for the constituents Y (12) and X (16) to be able to display their chemical actions based on their respective chemical affinities.

This use is characterized in that the substance used for the phase transfer is selected so as to be simultaneously functionalized for the future use of the nanoparticles.

The target solution can also be a solution comprising water-soluble compounds, in particular alcohols, in a concentration of from 0% to 100%.

The basic idea of the present invention is thus to select the phase transfer reactant, i.e. the “substance” in the abovementioned sense, both for the phase transfer and also with a view to the future use of the nanoparticles and to configure it according to the desired chemical functions of its constituents X, Y and Z.

There is thus a generic class of substances for the reactant, which class is hereinafter abbreviated as “MM” and comprises the abovementioned constituents. The addition of the reactant substance results in the nanoparticles readily going over from the organic phase into the inorganic phase in a single-step process. This produces an aqueous solution of nanoparticles whose concentration depends on the amount of water added. The transfer can be accelerated by introduction of energy, for example in the form of stirring or shaking of the mixture. When the amount of water is equal to that of the organic solvent, the concentrations in the water are, as desired, as high as those in the organic solvent before the phase transfer.

Advantageously, a simple separation of the inorganic phase from the organic phase can subsequently be carried out after a sufficient delay time, since the usually denser inorganic phase can easily be separated from the organic phase.

The subordinate claims provide advantageous embodiments of and improvements to the respective subject matter of the invention.

To enable the constituent Y of the reactant to be detached readily from the nanoparticles after phase transfer has occurred, it is proposed that a reversible bond between the nanoparticle surface and the constituent Y of the phase transfer substance coupled thereto be used. For the present purposes, a “reversible” bond means essentially a type of bond which is mainly due to van der Waals forces. At least a strong covalent or an ionic bond to the nanoparticle should thus be ruled out here so as not to endanger the ready removability of the shell molecules from the nanoparticle surface 10.

In particular, it is proposed for this purpose that the commercially available 4-dimethylaminopyridine, hereinafter referred to as DMAP for short, e.g. in aqueous solution, be added in a sufficient amount to the organic solution. As a result of its ring shape, the pyridine simultaneously represents the spacer constituent Z and the coupling constituent Y. The nitrogen atom in the ring binds to the nanoparticle surface. This is in most cases a relatively weak type of bond which is nevertheless sufficient to stabilize the nanoparticles in aqueous solution.

The addition of DMAP simply in a minimum amount without having to pay attention to keeping below a maximum amount in relation to the amount of starting solution is an advantage compared to the abovementioned prior art of Liu et al. The DMAP shell molecules around the nanoparticles can easily be washed off again after phase transfer has occurred, for example by means of toluene, should this be necessary for any reason. Such a reason can be, for example, the creation of very large free nanoparticle surface areas which are to be available in active form for catalytic purposes, or when an electric current is to flow with very little resistance through a layer of metal nanoparticles. Here, the shell molecules would otherwise increase the resistance, since the metal nanoparticles do not touch.

Should, on the other hand, a very stable bond be wanted between shell molecules and nanoparticle surface after phase transfer has occurred, as is desirable for many applications, the substance is, according to the invention, selected so that an effectively irreversible type of bond is obtained. This can be achieved, for example, by means of a covalent bond between nanoparticle surface and the coupling constiuent Y of the MM. A preferred substance for this purpose is mercaptoundecanoic acid (MUA).

As can be derived directly from the above, the preparative methods of the prior art for nanoparticles or colloids which are based on an organic synthesis can be supplemented quite generally by the phase transfer process in accordance with the first main aspect of the invention which follows the synthesis so as to achieve many advantages.

The abovementioned MM substances have the following generic chemical formula: X----Z-----Y

This generic formula comprises an organic spacer Z, a hydrophilic constituent X bound thereto and a constituent Y which is likewise bound to Z and can bind to the surface of the colloid or nanoparticle. Examples of such substances are 4-dimethylaminopyridine and the abovementioned concentrated 11-mercaptoundecanoic acid (MUA) solution in toluene.

The constituent X is selected so that it chemically changes the surface properties of the colloids or nanoparticles so that phase transfer in the abovementioned sense can occur. It can advantageously be or contain a functional group. In particular, the constituent X which points away from the nanoparticle surface can be deliberately chosen so as to have a reactivity which makes it particularly suitable for the further use of the nanoparticles. For example, it can serve to couple to biologically derived molecules, e.g. particular proteins, so as to be transported with the protein as carrier to cancer cells. After attachment, cancer cells can then be combated by targeted effects by exploiting physical or chemical prpoperties of the nanoparticles in a targeted fashion. An example which may be mentioned is increasing the temperature of the nanoparticles in a targeted manner by irradiation, so that the nanoparticles then transfer their energy via heat conduction to the cancer cells which can then be made harmless in this way.

The spacer constituent or constituents Z has to be able to link at least the constituent Y and the constituent X (16), and it has to have a molecular size which is sufficiently large for the constituents Y and X to be able to display their chemical actions based on their respective chemical affinities. It is possible for a multiatom compound, for instance a cyclic compound, to be able to perform the functions of two of the three constituents, or even of all three constituents.

In this way, the most recent advances in the prior art, namely the ability to synthesize virtually all relevant materials as nanoparticles in an organic phase, can now be directly utilized in an economically advantageous fashion, since they can be kept in aqueous solution in very high concentration using MM as stabilizer. The concentration can also be increased by, for example, distilling off part of the water, or adding the MM as a solution in only relatively little water.

The constituent X preferably has hydrophilic properties with an affinity to water which is sufficiently great to effect phase transfer.

In this way, inorganic colloids, in particular nanoparticles, which have diameters in the range from 0.1 nm to 1000 nm or larger in the case of colloids and have been obtained by reactions of inorganic salts or a mixture of inorganic salts in nonaqueous solvents can be transferred into aqueous or alcoholic solutions by a sufficient amount of substances designated as MM being absorbed onto them.

The use of a thiol as constituent Y and a carboxylic acid as constituent X in the substance used according to the invention is advantageous.

If the constituent Y is selected so that it forms a covalent bond to the colloid surface, for instance as in the case of the use of MUA with an aliphatic compound as MM, a stable, permanent bond which is desirable for many applications, for example in the production of paints, inks, etc., is obtained.

If the constituent Y forms a noncovalent bond to the nanoparticle surface, this has the advantage that the surface of the nanoparticles is modified only temporarily and not permanently. This can be achieved, for example, by use of DMAP having a conjugated bond. Washing enables the nanoparticle surface to be exposed again in unmodified form after phase transfer has occurred. Thus, for example, adjacent nanoparticles can conduct electric current when metallic nanoparticles are used. Furthermore, a washed surface of the nanoparticles can be exploited in an advantageous fashion, for example in catalysis to increase its efficiency.

The chemical action of this particular measure according to the invention is produced by application of MM to the surface of nanoparticles, e.g. metal or noble metal nanoparticles, gold, silver, iridium, platinum, palladium, without modifying it by means of a covalent bond as is the case in the prior art, for example with formation of a shell of gold sulfide around a nanoparticle. An example of a molecule used according to the invention comprises essentially a hydrophilic part which readily couples to water, a further part which couples to the nanoparticle and a spacer located between them. The abovementioned DMAP is an example of such a molecule.

In its broadest form, the phase transfer process of the invention for colloids and in particular nanoparticles is as follows:

A process for transferring colloids, in particular nanoparticles, from an organic starting solution into a target solution, where the target solution is either an inorganic, in particular aqueous, solution or a solution comprising water-soluble compounds, in particular alcohols, in a concentration of from 0% to 100% is disclosed and claimed. It is characterized by the steps:

a.) addition of a sufficient amount of a preselected substance as claimed in any of the preceding claims to the organic starting solution,

b.) allowing the nanoparticles to go over from the organic phase to the inorganic phase,

c.) separation of the inorganic phase from the organic phase. In this way, high nanoparticle concentrations are obtained in the target solution, with the concentration being dependent on the amount of target solution which is originally present or is added to the starting solution.

If an MM substance used according to the invention, i.e., for example DMAP or MUA, is added as an aqueous solution or a solution comprising water-soluble compounds, in particular alcohols, in a concentration of from 0% to 100% at a predetermined concentration in the solution, the process can be matched to the respective production requirements. In particular, aqueous solutions having very high concentrations of nanoparticles can be produced.

When the amount of the MM substance added is sufficiently large to form a monolayer around a nanoparticle in the solution, a high stability of the nanoparticles is obtained, particularly in the case of MUA as MM substance.

The ratio of the number of surface atoms of a nanoparticle to the number of the MM molecules bound thereto is preferably in a range from 0.1 to 10, more preferably about 1.

It is possible to transfer metallic colloids, in particular metallic nanoparticles, and colloids or nanoparticles of alloys in this way.

The transfer of nanoparticles of gold, silver, iridium, platinum, palladium, nickel, iron, rhodium, ruthenium or metal oxides, in particular iron oxide, zinc oxide, titanium dioxide, tin oxide, in each case results in desirable effects, for example colorants having long-term stability or coatings having other desired physical or chemical properties, e.g. electrical, magnetic or other properties.

Semiconductor nanoparticles and inorganic nanoparticles containing rare earth elements can also be transferred.

The additional step:

Separation of the colloids, in particular nanoparticles, from the solvent of the target solution to give a powder or slurry comprising particles, in particular nanoparticles, makes it possible to obtain a further state of the nanoparticles which may be a preferred alternative to the liquid form of the target solution for various types of further processing.

MM is advantageously added in an amount which is sufficiently large to form a monolayer around a nanoparticle in the solution. This layer thus contains the number of MM molecules required to cover the surface of the nanoparticle. However, a larger amount of MM is not harmful for the purposes of the invention. If gold nanoparticles are used, the ratio of the number of surface atoms of a nanoparticle to the number of MM molecules bound thereto is preferably in a range from 0.1 to 10, more preferably about 1.

High concentrations of noble metal nanoparticles:

according to the invention, noble metal colloids can be used as solutions in water and in a form which can be specifically matched to the future use of the nanoparticles. This reduces transport costs, since the achievable concentrations can be increased by a factor of from 10⁶ to 10⁹ compared to present-day concentrations in water. As a result, the transport weight of a solution containing the nanoparticles is reduced by the same factor while maintaining the chemical activity. However, the term “high” concentration is also used to refer to concentrations which are less than 10⁶ times the concentrations in water which are obtainable at present, as are, for example, marketed commercially at the present time.

In this way, water-based, colorfast colorants having long-term stability can be produced. Lipsticks, motor vehicle paints and even printing inks can profit considerably from these properties.

This is because such inks can be printed when produced according to the invention because the colorants produced according to the invention no longer block very fine nozzles of a printing machine, e.g. an inkjet printer, as a result of the small size of the color-imparting nanoparticles. A paint or surface coating according to the invention is much finer in terms of its surface and interior structure compared to paints having larger micron-sized pigment particles of the prior art. As a result, a paint is suitable for the first time for many fields of application, since the paint layer no longer flakes off as easily because of its homogeneous structure.

At least the following uses of the target solution or powder or slurry are encompassed by the present invention:

For the selective coating of surfaces of macroscopic bodies, or as paint/ink, in particular as printing ink, or surface coating, or for attachment to biologically derived molecules, in particular as biomarker;

for the production of structures which are applied to a support body and have predetermined magnetic properties;

for the production of structures which are applied to a support body and have predetermined electrical properties;

in sol/gel processing; or the use of a target solution to coat support particles with at least one layer of colloids, in particular nanoparticles, with there being sufficient affinity between support particles and colloid or nanoparticles for this purpose. This process step can be one of mixing a support solution containing the support particles with the target solution. Alternatively, the support particles can be mixed in another form into the target solution.

The additional step can be carried out to remove residues of the MM substance by washing with a suitable (organic) solvent.

For many uses of the aqueous solutions of the invention, for example for surface coatings in the motor vehicle sector, an aqueous solution can be firstly applied as such or in admixture with another component to small support particles (beads), for example by spraying by the inkjet process according to the prior art, to be added in a later step as component for a surface coating to one or more other components, and can be applied in a customary manner together with this and homogeneously distributed therein to the article to be coated. Spraying onto beads is known per se from the prior art, for example in pearl-effect or metallic surface coatings.

The abovementioned support particles (beads) are, owing to the ready handleability, an independent subject matter of the claims when provided with nanoparticles from aqueous, high-concentration solution. Their size is in principle dependent on the prior art paint application process chosen in the particular case. Such support particles can then be used industrially in accordance with the desired function of the nanoparticle properties.

Nanoparticles having a functionalized shell can be particularly advantageously applied to particularly small support bodies having a size of 0.02 micron or larger. Depending on the desired further use of the system comprising support bodies and nanoparticles, it is then wished to leave the shell of nanoparticles thereon (in which case MUA, for example, should be used) or to be able to remove them relatively easily (in which case DMAP is appropriate), for example by washing with toluene.

Particularly useful nanoparticles of this type are noble metal, in particular gold (Au), nanoparticles having a DMAP shell when they are applied, for example, to polyelectrolyte-coated spheres of polystyrene, polymethyl methacrylate (PMMA) or silicon oxide, etc., and are then treated with a solution comprising hydroxylamine hydrochloride and hydrogen tetrachloroaurate (electroless plating) to remove the reversibly bound MM substances, e.g. DMAP or residues thereof, to form a coherent metal shell or gold shell on the cores of the spheres. Such spheres/surfaces can then be advantageously employed in a wide range of industrial or medical applications, for instance in the field of photonics, cancer therapy, pharmacy and catalysis, as mentioned above. According to the present invention, spheres having a high loading of nanoparticles can be produced in a single absorption step, giving a high level of homogenous shells. Here too, considerable advantages are achieved by means of the invention, in each case specifically according to the application.

A further independent subject matter of the invention comprises colorant liquids into which the nanoparticles have been introduced from aqueous solution according to the invention.

Furthermore, the invention advantageously provides a primary color set of aqueous solutions for producing mixed colors, using gold nanoparticles for producing the primary color red, silver nanoparticles for producing the primary color yellow and iridium nanoparticles for producing the primary color blue. Using appropriate amounts of the primary colors, it is therefore possible to produce all mixed colors in a customary fashion, e.g. the mixed color green by mixing aqueous solutions or beads containing iridium nanoparticles (blue) and silver nanoparticles (yellow).

When metallic nanoparticles are transferred in the process of the invention, this results, owing to the wide range of process end products, in highly concentrated nanoparticle solutions containing the respective desired metals. When, for example, an iron solution and a platinum solution are prepared, a contribution can be made to producing sprayable liquids for producing magnetizable or permanent magnetic or electrically active structures, for instance conductor tracks, sprayed or otherwise applied onto a substrate, by means of which, for example, very finely structured data storage media can be “printed”. These can then be read or written on in a known manner by means of an induction head of appropriately small size.

According to a second main aspect of the present invention, the inventive principle can be applied directly to carrying out a catalytic reaction, either a homogeneous or heterogeneous catalysis which can be applied in the customary fields, e.g. polymer production, and is thus of immense importance for many chemical processes carried out industrially and processes occurring in everyday life:

According to this aspect, noble metal nanoparticles, for example, which may be added, for example, as an organic solution to an organic reaction mixture act as catalyst. They disperse uniformly (homogeneously) in the reaction liquid and are not bound to support molecules such as Ceolite, as a result of which they display a catalytic efficiency which is many times higher than that in heterogeneous catalysis with appropriate binding to a support such as Ceolite, carbon, etc.

It is then possible to carry out the fundamental reaction, where the catalytic action is advantageously brought to bear because now many times the surface area, e.g. 200 m² per gram for 6 nanometer nanoparticles, is catalytically active compared to heterogeneous catalysts in which a major part of the catalyst has to remain chemically inactive because it remains hidden in the interior of the support molecule.

After the reaction is complete, the catalyst should advantageously be able to be removed again from the reaction mixture. This is achieved by adding water and a substance according to the invention. The nanoparticles then go back, as described above, from the organic phase into the water and thus can advantageously be recovered completely. At the same time, the reaction mixture is advantageously freed of the catalyst.

The application of nanoparticles to a substrate suitable for a heterogeneously catalyzed process, e.g. Ceolite or carbon, using an aqueous solution having a high concentration of nanoparticles, e.g. gold or platinum nanoparticles, which may have been obtained according to the invention can be improved according to the invention by the nanoparticles being able to be applied to most hydrophilic support materials in a simpler manner, for example without evaporation of the nanoparticle solution, when the aqueous solution of the invention is added. This makes catalysts used industrially simpler to produce and cheaper.

The phase transfer process of the invention is applicable to all nanoparticles which are disclosed in the associated patent application PCT/DE-00/03130. In this way, the present process can be combined in an advantageous manner with the disclosure of the patent application mentioned, resulting in the advantages known to a person skilled in the art.

### DRAWINGS

Examples illustrating the invention are depicted in the drawings and are described in more detail in the following description.

In the figures:

FIG. 1 schematically shows a nanoparticle with coupled-on MM molecules having, by way of example, the DMAP structure;

FIG. 2 shows a photograph of the gold nanoparticles in a 2-phase mixture before (at right) and after (at left) transfer within 2 mL Eppendorf tubes;

FIG. 3 shows a transmission electron micrograph of the gold nanoparticles from FIG. 1 after they have been transferred into water;

FIG. 4 shows photographs of 5 different nanoparticle samples in pairs (A,B), (B,C), . . . in each case before and after phase transfer using MUA as MM,

FIG. 5 shows UV/VIS spectra of gold nanoparticles in toluene (continuous line) and after transfer (broken line),

FIG. 6 shows transmission electron micrographs of gold nanoparticles after their preparation in toluene (A) and 1 month after transfer,

FIG. 7 shows transmission electron micrographs of palladium nanoparticles in toluene (A) and after transfer into water (B), effected by means of DMAP as M,

FIG. 8 shows EDAX spectra of palladium nanoparticles as synthesized (top) and after phase transfer into water (bottom),

FIG. 9 shows a sketch of a mechanism (scheme 1) for the phase transfer of gold and palladium nanoparticles from toluene into water by addition of DMAP, R=C₈H₁₇,

FIG. 10 shows photographs which illustrate the phase transfer as a function of time; gold nanoparticles from toluene into 0.1M DMAP solution.

### DESCRIPTION OF THE EXAMPLES

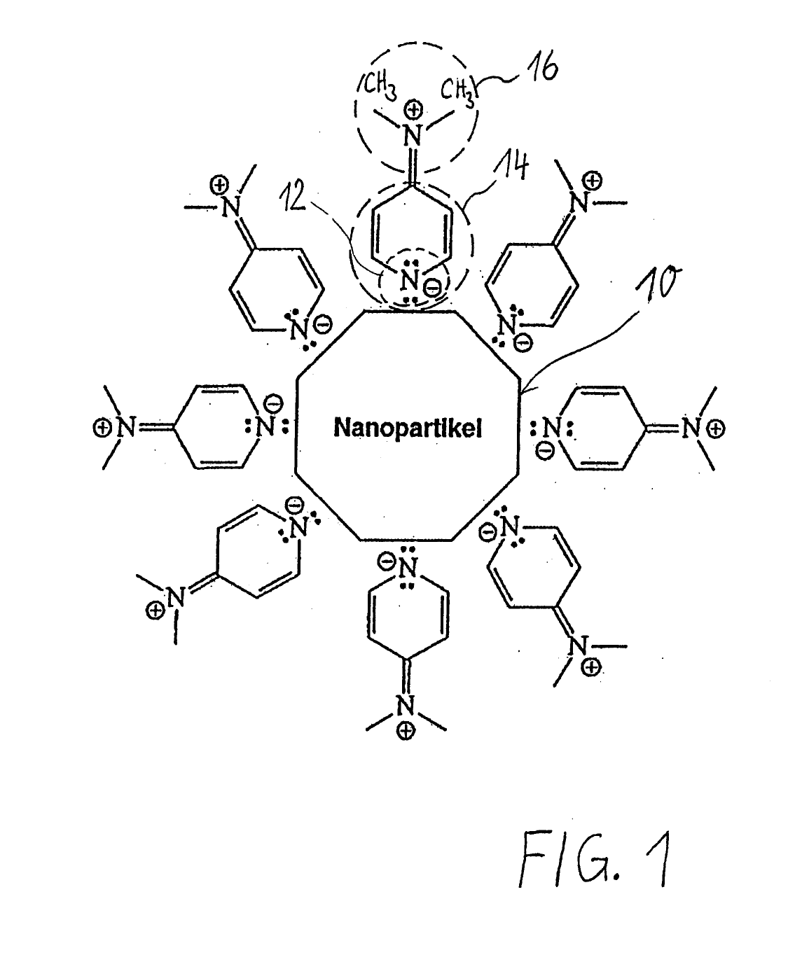

FIG. 1 schematically shows in the center the surface 10 of a gold nanoparticle. The surface is drawn as a line having a smooth contour which is shown by way of example and purely schematically as an octagonal shape. The surface is shown in idealized form as a smooth surface, but is made up of individual gold atoms.

Eight DMAP molecules are shown schematically coupled onto the surface 10; of these, only one (the uppermost) is shown in greater detail in the interest of simplicity. Depending on the size of the phase-transferred nanoparticles, a considerably greater number of shell molecules are naturally arranged in the plane of the drawing. The description below applies likewise to the other DMAP shell molecules which are bound to the nanoparticles (including those located outside the plane of the drawing):

The endocyclic nitrogen (N) atom 12 of the pyridine ring binds, as constituent Y of the DMAP molecule used according to the invention, to the nanoparticle surface 10. The pyridine ring 14 itself acts as spacer Z to the hydrophilic dimethylamine 16 depicted at the top, which forms the constituent X of the MM molecule.

The chemical action is brought about by the application of the DMAP molecules to the surface of nanoparticles, so that at least a large part of the surface of the nanoparticle is occupied by such molecules in the form of a monolayer with gaps which are not too large. If no gaps are present or a surplus of DMAP molecules is present, this does not impair the desired action.

In this example, a readily removable layer is therefore formed around each individual nanoparticle without the surface of the particle being modified, as is the case in the prior art, for instance in the formation of a shell of gold sulfide around a nanoparticle.

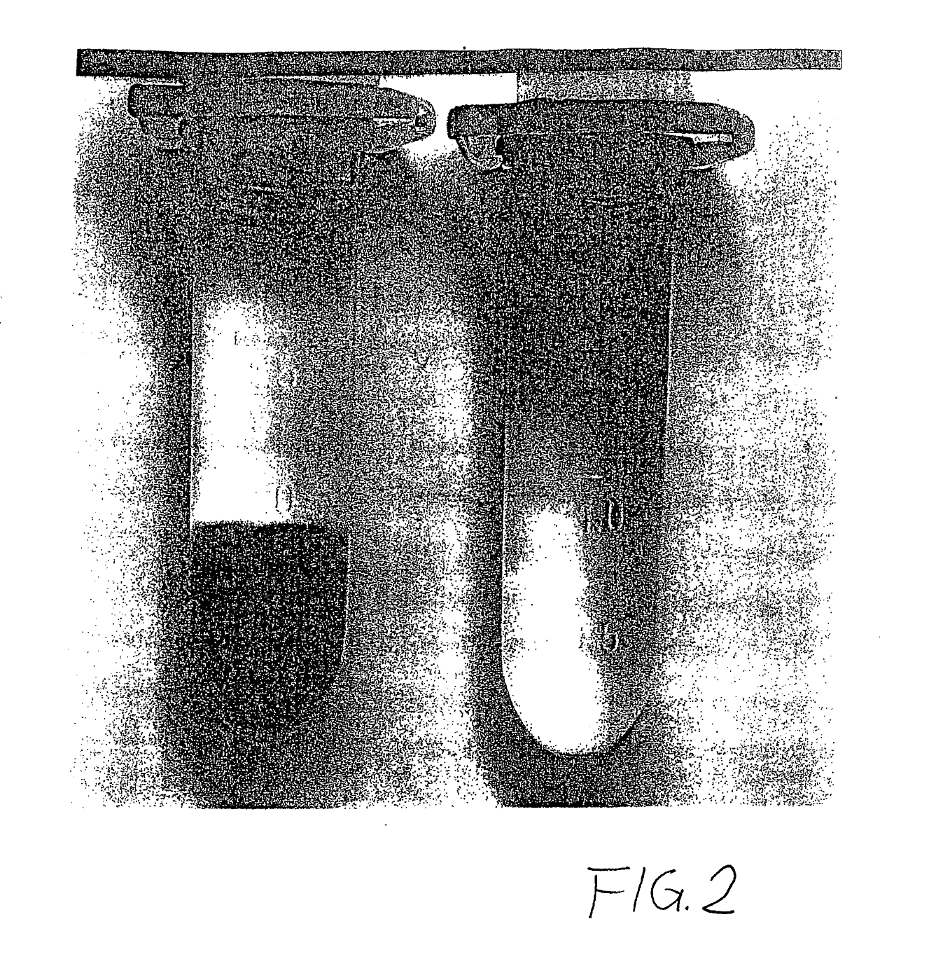

FIG. 2 shows a photograph of the gold nanoparticles in a 2-phase mixture before (at right) and after (at left) transfer in 2 mL Eppendorf tubes. The upper phase is toluene, and the lower phase is water. It can clearly be seen from the Figure that no agglomeration of nanoparticles has taken place, neither in the organic phase nor in the inorganic phase.

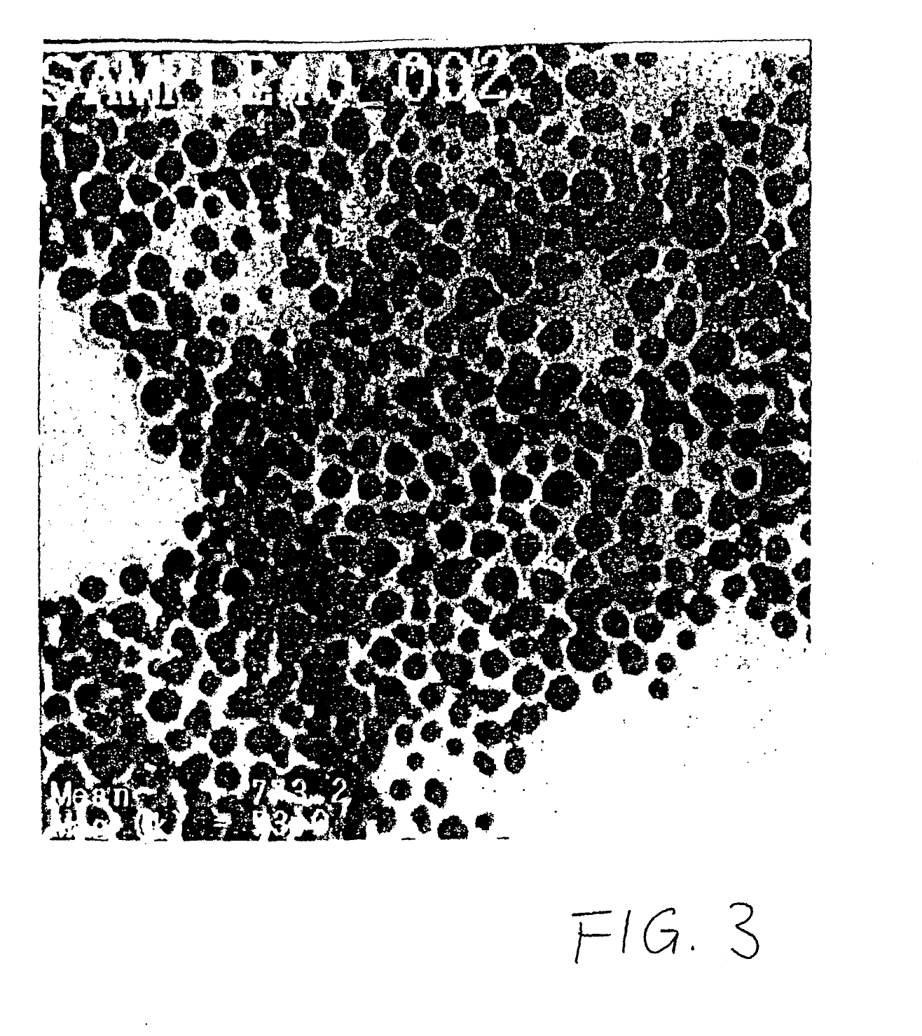

FIG. 3 shows a transmission electron micrograph of the gold nanoparticles of FIG. 2 after they have been transferred into water. Here too, it can clearly be seen that neither agglomeration nor a change in the size, shape or morphology of the nanoparticles has taken place during phase transfer.

Even 6 months after phase transfer, the transferred particles display no signs of decomposition or aggregation. It can therefore be assumed that they are stable for an indefinite time. Advantageously, this process requires neither precipitate formation nor solvent replacement, and the particles transferred by means of the process are not stabilized by covalently bound ligands. With a view to subsequent uses, this is an important difference from thiol-stabilized particles. The availability of such concentrated, aqueous solutions of nanoparticles opens up new possibilities for cyto-labeling, heterogeneous and homogeneous catalysis, solid state physics and for applications in the field of colloidal crystals.

In addition, it is in principle possible to carry out coating of surfaces with the purpose of changing the surface so that it takes on certain, desired properties of the nanoparticles or properties of elements which are present in the nanoparticles.

Further applications exist in the field of homogeneous or heterogeneous catalysis, as are described below. Since the nanoparticles are readily available industrially due to their presence as fine dispersions in aqueous solution or in, for example, alcohol-enriched solution, they can also be applied to, for example, small support particles, viz. beads. Suitable support particles have a size in the range from about twice the size of the nanoparticles used (in the case of a homogeneous size distribution), i.e. from about one nanometer, through to the macroscopic range, i.e. up to several millimeters in size.

Here there are possible industrial applications in the field of colloidal crystal applications and photonics, in the field of optical waveguides for telecommunications for producing desired, optical lattice properties.

The steps for preparing the phase-transferred nanoparticles are indicated below:

All chemical starting materials necessary for the examples described below were used as they are commercially available from SIGMA-Aldrich. The water used was passed through a MILLIPORE purification system before use; after this treatment it has a resistance of greater than 18 M Ω cm. UV/VIS samples are placed in fused silica cells (Hellmar, SUPRASIL, path length −1.000 cm) and measured using a double-beam spectrophotometer (CARY 4E, Varian).

A solvent spectrum is subtracted from all spectra. Samples which require sedimentation are centrifuged in 2 ml Eppendorf tubes which can be stood upright (3K30, SIGMA Laboratory Centrifuges). Samples for TEM measurement (Philips CM70, acceleration voltage=120 kV) are applied to copper grids provided with a standard carbon layer and dried before examination. The particle size distribution is determined by means of ultracentrifugation using absorption optics (Beckmann Optima XL-I) or by TEM analysis. Samples for TEM analysis are prepared by placing a drop of this solution on a carbon-coated copper grid and drying it in air.

The particles are synthesized by methods published in:

Hayat, M.A. (Academic PressInc., San Diego, USA, 1989), or in Goia, D.V. & Matijevic, E. Tailoring the particle size of monodispersed colloidal gold. Colloids Surf. A 146, 139-152 (1999), or in

Green, M. & O'Brien, P. Recent advances in the preparation of semiconductors as isolated nanometric particles: new routes to quantum dots. Chem. Commun., 2235-2241 (1999).

In case of doubt, the disclosures of these sources can be consulted.

1)

One milliliter of an aqueous 4-dimethylaminopyridine solution (DMAP) are then, according to the invention, added to a one milliliter aliquot of nanoparticle mixtures, for example comprising gold, silver, iridium, platinum, palladium, rhodium or ruthenium, synthesized in toluene and stabilized by the tetraalkylammonium salt method. Larger volumes of nanoparticles in their reaction solution can likewise be transferred successfully into one milliliter of water, which makes subsequent recycling of the ammonium salt possible. Direct phase transfer through the organic/aqueous boundary is complete within a period of from one hour to three hours without any further action being necessary. More rapid phase transfer can be achieved by, for example, the use of centrifugation, shaking, stirring, i.e. introduction of energy. This gives high concentrations of the nanoparticles which can be diluted by a factor of about 1000 for subsequent use (analysis, photography).

2)

100 microliters of a concentrated 11-mercaptoundecanoic acid (MUA)/toluene solution are added to a 1 milliliter aliquot of the nanoparticle mixture as has been described above, i.e., for example, comprising gold, silver, platinum, iridium, etc. and synthesized in toluene and stabilized by the tetraalkylammonium salt method or synthesized by the Wilcoxon-AOT method as disclosed in U.S. Pat. No. 5,147,841, with no prior purification being necessary. The adsorption of the phase transfer catalyst can be observed with the naked eye as a red shift in the color of the solution, followed by development of turbidity produced by particle agglomeration and precipitation. Coated particles can either be carefully centrifuged from the organic solution or can be left to sediment overnight. Washing the precipitate with 2 aliquots of the starting solution, followed by one aliquot of methanol removes all by-products of the reaction and the excess of phase transfer catalyst. This is followed by washing with methanol.

Careful shaking of the precipitate in basic water results in a stable, clear solution of the nanoparticles. Since the particles are added as solid to the water, solutions of any concentration can be produced.

A phase transfer carried out using MUA results in a precipitate which is stable for a long period when stored as, for example, powder or slurry. This applies particularly when MUA molecules envelop the nanoparticles so completely that the particles do not come into contact with one another. No agglomeration or clumping together is therefore possible.

3)

10 microliters of mercaptopropyltrimethoxysilane are added to a 1 milliliter aliquot of the gold nanoparticle mixture as can be prepared by the method described above, synthesized in toluene or synthesized by the Wilcoxon-AOT process, U.S. Pat. No. 5,147,841, without prior purification. The adsorption of the phase transfer catalyst can be observed with the naked eye as a red shift in the color of the solution followed by development of turbidity caused by particle agglomeration and precipitation. Coated particles can either be centrifuged carefully from the organic solution or can be sedimented overnight. Washing of the precipitate with two aliquots of the initial solution followed by one aliquot of methanol removes all by-products of the reaction and excess phase transfer catalyst.

The phase transfer catalyst is added to the organic nanoparticle solution at a metal concentration of from 1×10⁻⁶ to 100% by weight, in particular 1 mg per ml of metal in a concentration of from 1×10⁻⁶ to 100% by weight, in particular equal volumes of a 0.01M aqueous solution. This results in complete phase transfer from organic solution to water.

As can be seen from the description above, the phase transfer of the nanoparticles from organic solution into aqueous solution as disclosed according to the invention can be achieved by means of the two examples above. It is also possible to employ other substances if they have the required binding properties, cf. above description for FIG. 1.

The phase transfer process of the invention can be used advantageously for metallic nanoparticles such as gold, silver, iridium, platinum, palladium, nickel, iron, metal oxide, in particular iron oxide, zinc oxide, titanium dioxide and tin oxide nanoparticles and also for rhodium and ruthenium nanoparticles. In this way, colorants which are present in aqueous solution and are stable for a prolonged time can be obtained in an advantageous fashion. These can thus also be employed for applications in which use of such nanoparticles in organic solution is normally ruled out for environmental reasons, or on health grounds or for other reasons. The process as described above can likewise be used for marking materials in electron microscopy.

Semiconductor nanoparticles can likewise be transferred.

The following applications and advantages are made possible:

Biological applications, in particular bio-labeling, production of lighting effects by means of fluorescence, and other applications which are disclosed in the abovementioned patent application which has been submitted simultaneously,

all applications related to environmental protection which profit from the solubility of the nanoparticles in water instead of organics, regardless of the type of nanoparticles.

Furthermore, any inorganic, in particular aqueous, solution as is obtained by the process of the invention can be used and economically exploited in many ways. It can be used, in particular, as paint, paint component, printing ink or surface coating composition or as constituent of a surface coating. Advantages can be gained from the particular fineness of the nanoparticles and their narrow size distribution in cases in which a printing ink containing nanoparticles has to be passed through the fine nozzles of an inkjet printer. According to the invention, such nozzles then do not become blocked.

When a paint/ink containing such nanoparticles or a similar surface coating is applied to a substrate other than by passage through a nozzle, then the narrow size distribution and small size of the nanoparticles results in a paint layer or surface coating which is less brittle than when color-imparting particles having particle sizes in the micron range are used.

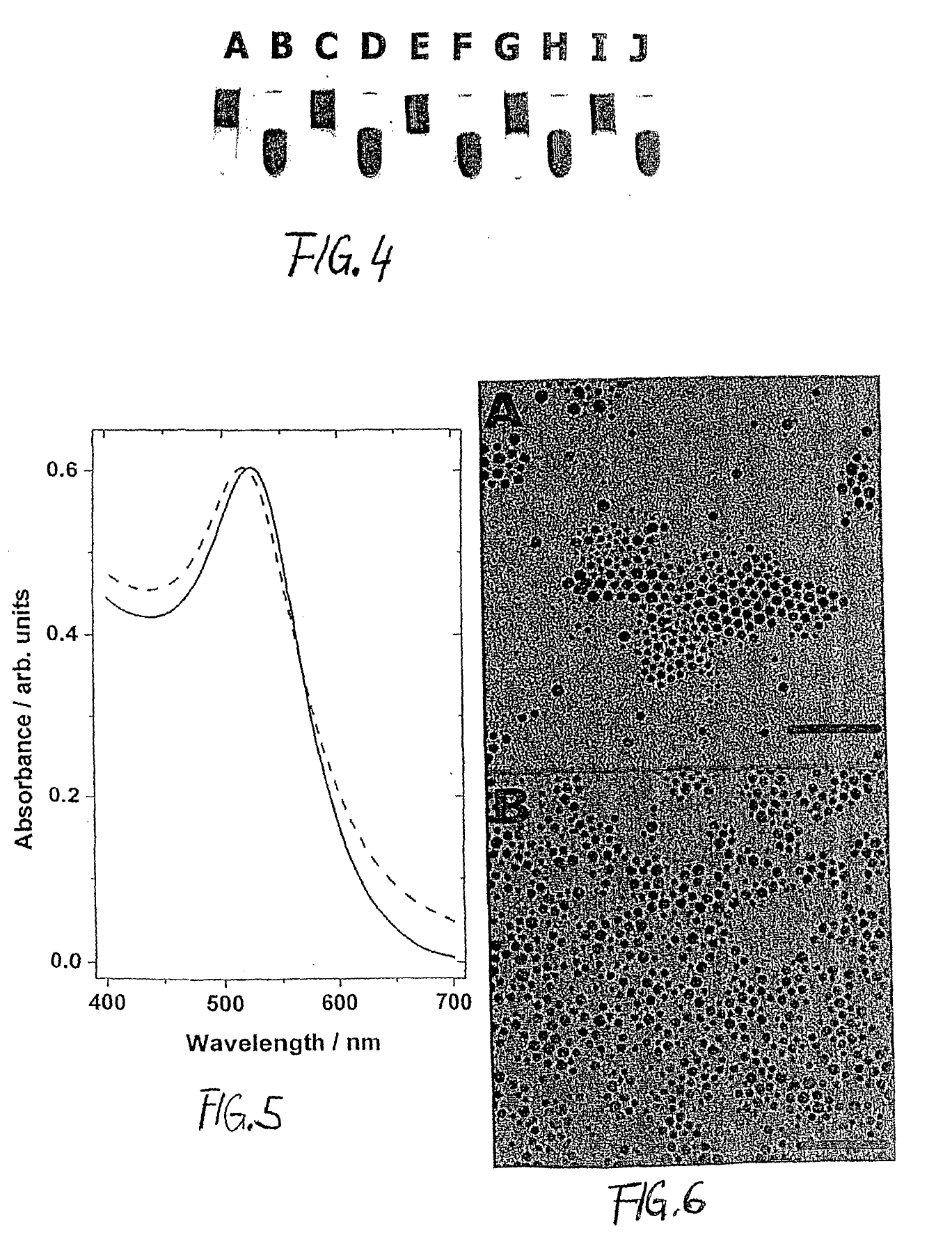

Complete phase transfer of the metallic nanoparticles is achieved, cf. FIG. 2. This is also shown in further examples in which complete phase transfer according to the invention occurs. Such results are shown in FIG. 4 ff. Here, the following experimental set-up was employed:

Synthesis of the nanoparticles: 30 milliliters of an aqueous solution of a metal chloride (HAuCl₄ or Na₂PdCl₄, 30 milliliters) were added to a 25 mM solution of tetraoctylammonium bromide in toluene (80 ml). The transfer of the metal salt into the toluene phase could be clearly recognized visually within a few seconds. A 0.4 M solution of freshly prepared NaBH₄ (25 ml) was added to the stirred mixture, resulting in immediate commencement of the reduction. After 30 minutes, the two phases were separated and the toluene phase was washed with 0.1 M H₂SO₄, 0.1 M NaOH and three times with H₂O and finally dried over anhydrous NaSO₄. Earlier high-resolution TEM analyses showed that nanoparticles prepared in a similar manner are crystalline and have a capped octahedral morphology.

Phase transfer: 1 ml of an aqueous 0.1 M solution of DMAP was added to aliquots (1 ml) of the nanoparticle mixture. This DMAP concentration was found to be sufficient to effect complete and spontaneous phase transfer of the nanoparticles. It should be noted that it was also possible to transfer nanoparticles from larger volumes of the reaction solution (up to 0.5 l) into water (1 ml) and to recover the tetraalkylammonium salt. The direct phase transfer through the organic/aqueous interface had proceeded to completion within one hour, without stirring or shaking being necessary.

Furthermore, it is also possible to add the DMAP directly to the toluene solution so as to precipitate the particles; these can then be resuspended in water. Phase transfer was also successful using similar particles synthesized in chloroform but not when using particles whose synthesis had been carried out using other organic stabilizers, e.g. sodium 5,14-diethyl-8,11-dioxo-7,12-dioxaoctadecane-2-sulfonate (Na AOT) or dodecyldimethylammonium bromide.

All reagents were purchased from Sigma-Aldrich and used without further pretreatment. The UV/Vis spectra were recorded on a UV/Vis spectrophotometer from Cary (Model 4E), resolution: 0.2 nanometers. The zeta potentials of the nanoparticles were determined using a Zetasizer 4 from Malvern, with the mean of five steady-state measurements being taken. The mobilities were converted into electrophoretic potentials by means of the Smoluchowski relationship. The TEM examinations were carried out using a CM12 microscope from Philips at 120 kV. The particle size distribution was calculated from the sedimentation velocities determined by analytical ultracentrifugation at 20° C. The measurements were carried out using an Optima XL-1 ultracentrifuge from Beckman-Coulter which was equipped with absorption optics for detection. “Home-made” double sector middle pieces of titanium having a diameter of 12 millimeters were used. In the analytical ultracentrifugation, a dilute sample of the nanoparticles is subjected to a constant centrifugal force. At the beginning of an experiment, a scan at a fixed wavelength over the radius of the cell gives a constant absorption value, which indicates a constant distribution of the colloids over the volume of the cell. During the experiment, the time-dependent sedimentation of the particles can be followed by sequential radial scans of the local colloid concentration. The fractionation of the particles during the experiment allows the distribution of the sedimentation coefficients to be calculated from a series of radial scans carried out at various times. In this way, both the density of the solvent and the viscosity of the solution and also the size distribution and density of particles can be determined, even when their size is in the Angström range.

FIG. 4 shows five diluted nanoparticle solutions in pairs from left to right, in each case before and after phase transfer. The particles can be seen by the dark color in the sample container. All primary colors can be produced, but of course cannot be seen in such a black and white depiction.

Phase transfers were in each case carried out from reaction mixtures (toluene) using MUA into water as mentioned above. Examples A, B showed the transfer of the silver nanoparticles, C, D showed the transfer of gold nanoparticles, E, F showed the transfer of platinum nanoparticles, G, H showed the transfer of further gold nanoparticles which have been produced in a different way, and I, J showed the transfer of palladium nanoparticles.

UV/Vis spectra of the dissolved gold nanoparticles were recorded before and after phase transfer, since particle aggregation, reversible or irreversible, flocculation or coagulation and also changes in the dielectric constant of the environment of the nanoparticles can be observed in a known manner in the optical spectra. In toluene, the maximum of the surface plasmon band was at a wavelength of 518 nanometers, as shown in FIG. 5. After phase transfer, the band had undergone a blue shift of 6 nanometers to 512 nanometers. This shift could be based on the combined action of the change in the index of refraction of the medium from 1.47 to 1.33 and the replacement of the adsorbed molecules during transfer. Any form of particle aggregation would lead to a red shift and a broadening of the plasmon absorption band. The UV/Vis spectra obtained thus clearly showed that the DMAP-induced phase transfer gives gold nanoparticles which are well dispersed in an aqueous solution. No UV/Vis experiments were carried out on the palladium nanoparticles, since they do not have a strong surface plasmon absorption band.

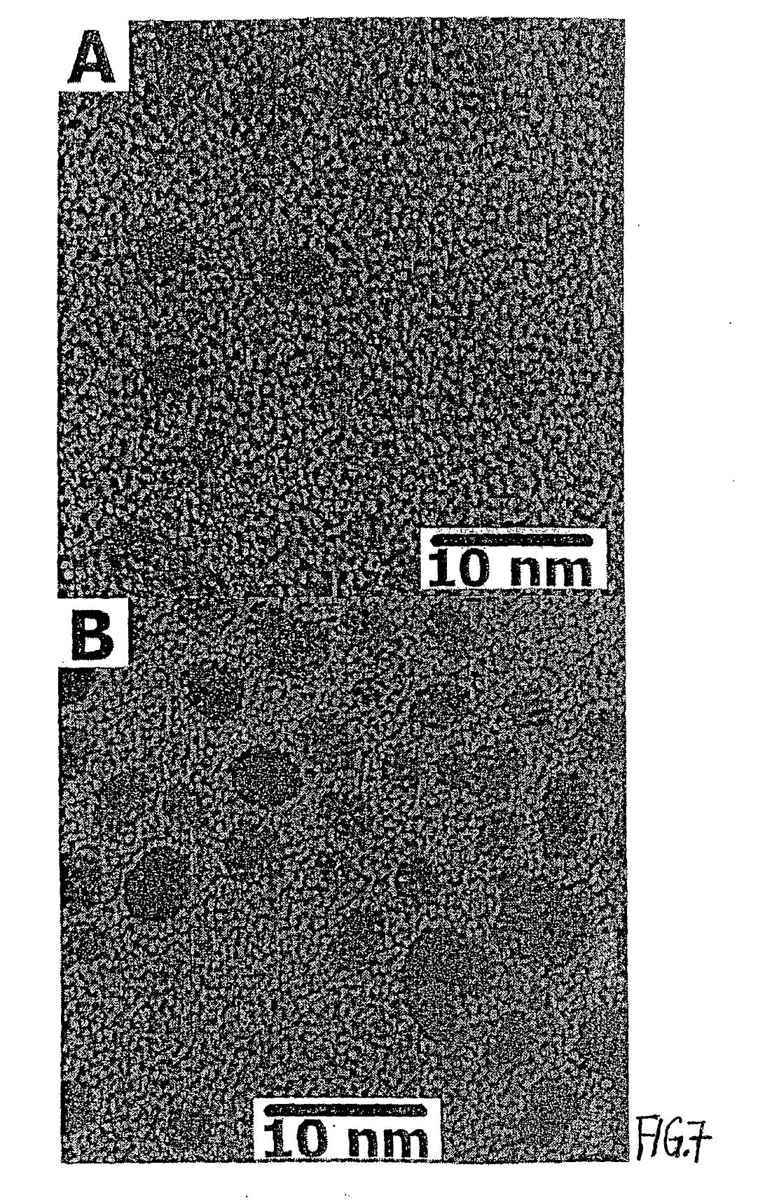

FIG. 6 shows results of transmission electron microscopy (TEM). TEM indicated no visible differences in the morphologies of the gold and palladium nanoparticles after phase transfer. This can be seen from the micrographs, where A in the upper region shows toluene-synthesized gold nanoparticles and the micrograph B shows the sample one month after transfer into water effected by addition of DMAP.

Analysis of the micrographs of the gold nanoparticle samples in both the toluene solution and the aqueous solution indicated a mean nanoparticle diameter of 5.5 nanometers with a standard deviation (SD) of 0.7. These figures are based on 153 particles, and an SD of 0.8 was obtained from a count of 115 particles.

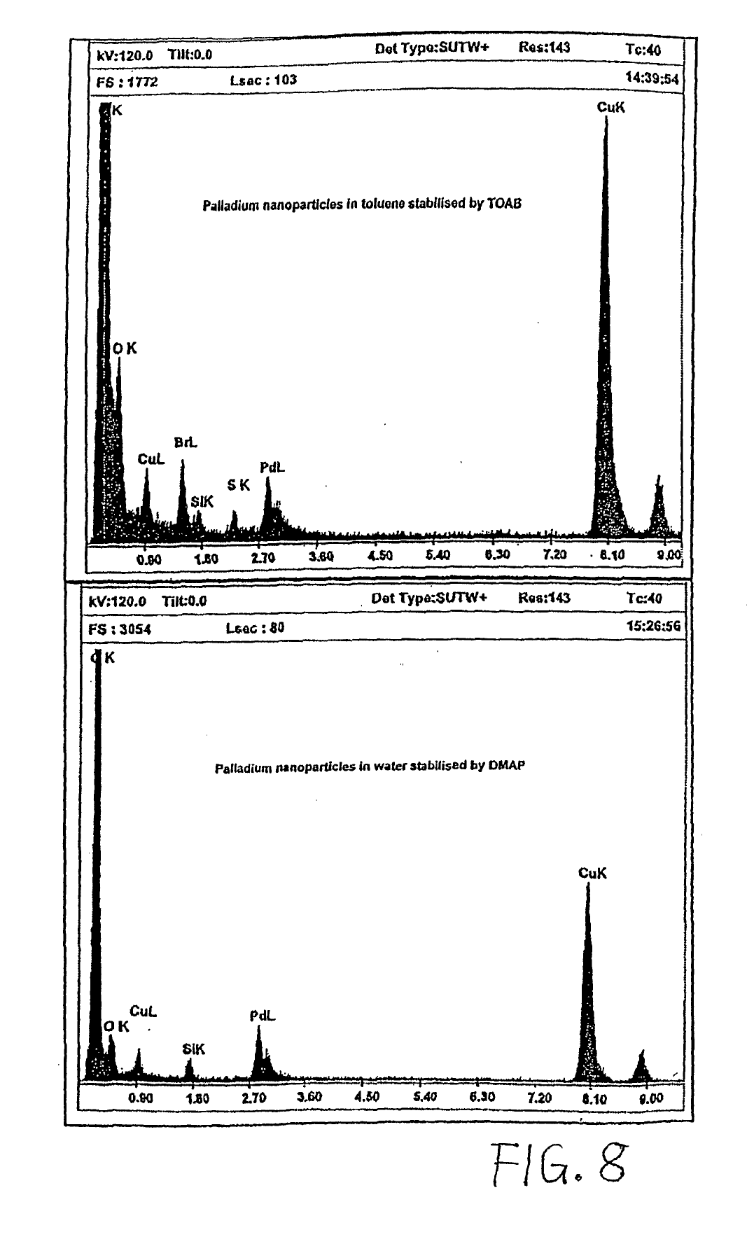

The palladium nanoparticles gave a mean diameter of 4.5 nanometers and an SD of 0.9 for 145 counted particles, and a diameter of 4.8 nanometers and an SD of 1.2 for 122 particles. This is shown in FIG. 7, where palladium nanoparticles synthesized in toluene are shown in the upper region A and the region B shows the same sample after transfer into water effected by addition of DMAP.

Energy-dispersive X-ray fluorescence analysis (energy dispersive analysis of X-rays, EDAX) indicates that no bromide ions are present on the particles which have gone over into the aqueous phase and have been dried on a TEM grid. It should also be stated that the bromide ions are the counterions of the tetraalkylammonium ions. However, traces of the organic salt can still be adsorbed on the particle surface.

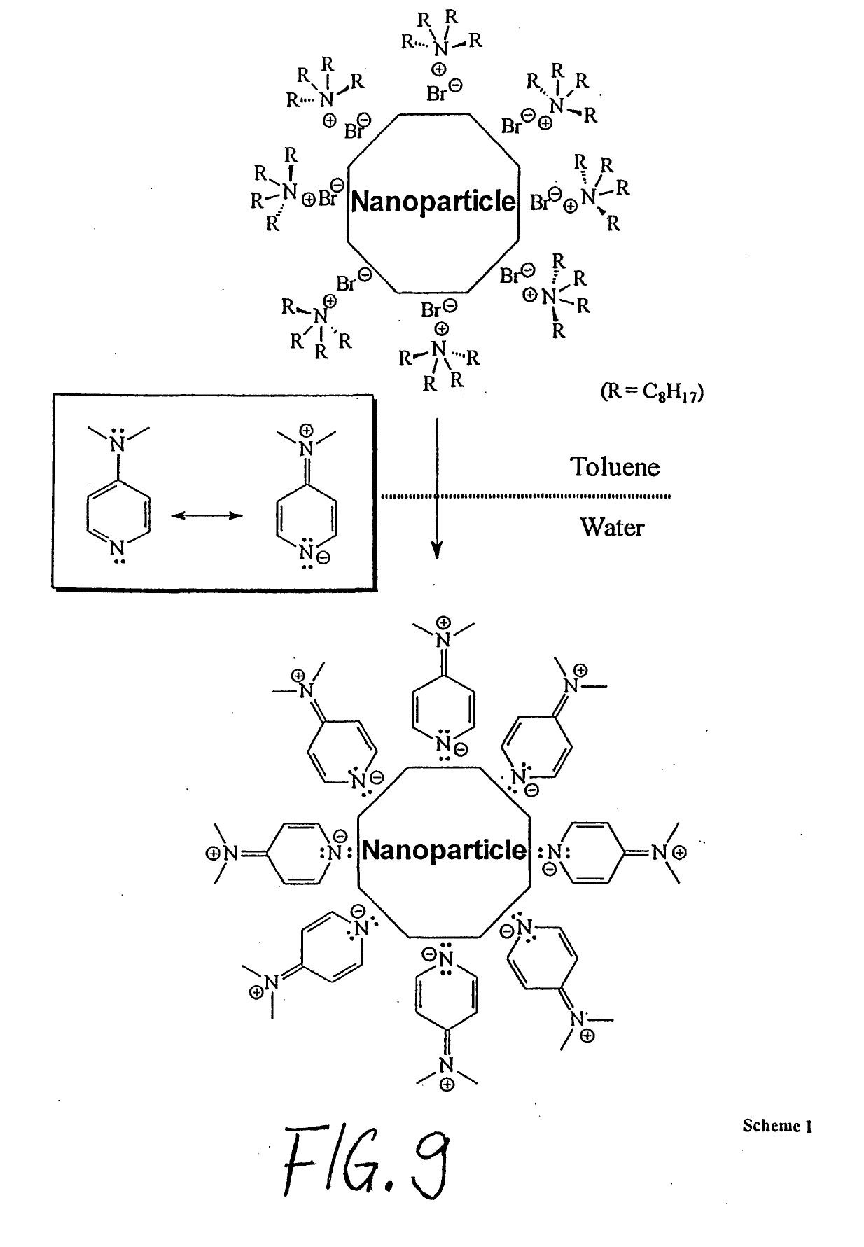

The EDAX spectra of palladium nanoparticles are shown in FIG. 8: “as synthesized” at the top and after phase transfer into water at the bottom.

Since the information on the morphology of the nanoparticles which is obtained by TEM relates to the dry state, measurements were also carried out by means of analytical ultracentrifugation (AU) in order to obtain the size distributions of the nanoparticles in solution.

AU analysis of the gold nanoparticle samples indicates mean diameters of 5.1 nm (SD=1.1) in toluene and 5.2 nm (SD=1.1) in water. AU analysis of the palladium nanoparticles indicated diameters of 2.8 nm (SD=1.5) and 3.1 nm (SD=1.6), respectively. These results agree well with the values determined by TEM and once again confirm that no significant aggregation of the nanoparticles has taken place as a result of the transfer.

The stability of the DMAP-stabilized particles was examined as a function of salt concentration and pH. All samples (Au. Pd. pH 10.5) were stable for a period of at least 6 months in 3M NaCl solution (for gold=514 nm). Determination of the zeta potential of the DMAP-stabilized nanoparticles in aqueous solution (pH 10.5) by means of microelectrophoresis gave an average value of +25 mV (from five measurements on samples from three different transfer experiments). This indicates a positively charged particle surface. The particles are stable as colloids (with a zeta potential of about 35 mV) in the pH range from 7 to 12, even though the proportion of flocculated particles increased (as could be observed visually; see background information) when the pH was decreased from 10.5 to 3.0 by stepwise addition of dilute acid (1 mM HCl, pH 3). This observation agrees with the postulated mechanism of phase transfer (see Scheme 1), since the decrease in the pH should lead to a greater proportion of the endocyclic nitrogen atoms being protonated and thus no longer being able to bind to the surface of the nanoparticles in order to stabilize them. As a consequence, regions of the nanoparticle surface were “deprotected”, which would lead to reversible aggregation. A decrease in the degree of particle flocculation (which can be recognized by the blue shift in the peak of the plasmon absorption band) was achieved by addition of a dilute base (1 mM NaOH), which again increased the pH to its original value (pH 10.5). The separation of the aggregated particles did not occur immediately, but could be detected only after a few days; however, the phenomenon was always repeatable. As would be expected on the basis of simple acid-base equilibria, increasing the pH of the solution to values above pH 13 by addition of a dilute base led to aggregation of the particles since the proportion of charged DMAP molecules decreases (pH=9.6).

To obtain a better understanding of the mechanism of the spontaneous transfer of the metallic nanoparticles from the organic phase into the aqueous phase, the effectiveness of various compounds was tested. These were in each case added as 0.1M aqueous solutions to aliquots of the solution of the gold nanoparticles. Pyridine and 4-aminopyridine led to immediate aggregation of the particles suspended in toluene, which could be recognized by a color change from red to blue and subsequent precipitation formation. Only in the container in which DMAP was present did transfer of the nanoparticles into the aqueous phase take place; in the case of the other samples, the precipitate formed collected at the interface between toluene and water. These results indicate that a tertiary (strongly basic) amino group conjugated to an electron-donating (weakly basic) group is necessary to bring about phase transfer. To demonstrate that strong covalent bonds have not formed between the stabilizing molecules (DMAP) and the surfaces of the metallic nanoparticles, the aqueous phase was washed a number of times with toluene. The DMAP content of the aqueous phase decreased continuously with increasing number of extractions, until the particles finally formed aggregates. This effect indicates that DMAP is detached from the particle surfaces. Covalently bound molecules cannot be removed by simple washing with a solvent.

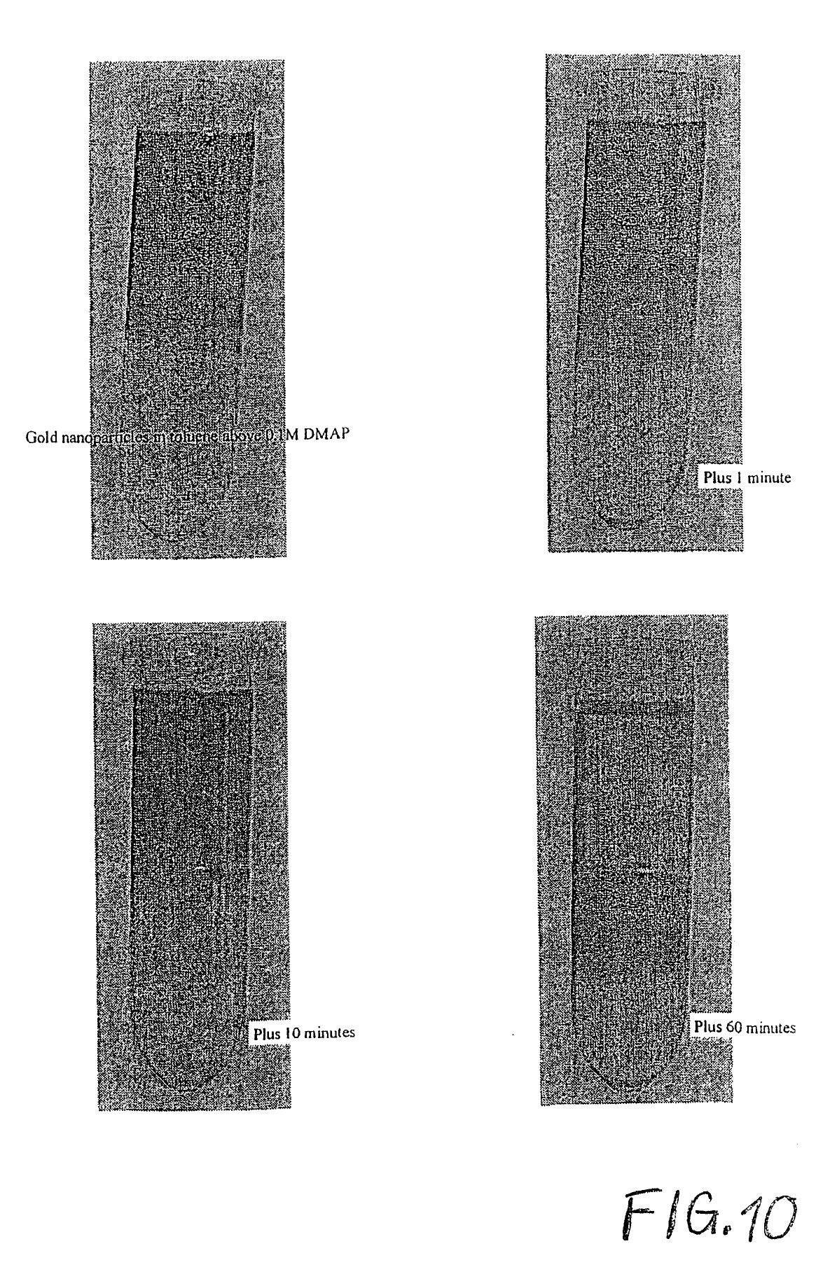

A possible mechanism of the spontaneous phase transfer of the nanoparticles in the presence of DMAP molecules is shown in Scheme 1 in FIG. 9: the addition of an aqueous DMAP solution to the dispersion of the nanoparticles in toluene leads to partition of the DMAP between the aqueous and toluene phases of the mixture (this was confirmed by thin layer chromatography of the organic phase) and to physisorption of the DMAP on the surface of the nanoparticles. Simple calculations of acid-base equilibria show that 98% of the DMAP molecules are present as free base in a 0.1 M aqueous solution. We assume that the DMAP molecules form labile donor-acceptor complexes with the atoms of the metal surface via the endocyclic nitrogen atoms, as has been described above for planar gold substrates; a charge on the surface is then necessary for transfer into the aqueous phase, and this can be achieved by partially protonating the exocyclic nitrogen atoms which point away from the surface of the nanoparticles.

FIG. 10 depicts photographs which show the progress of phase transfer over time: gold nanoparticles from toluene into 0.1M DMAP solution; at top left, immediately after initiation of phase transfer, at right beside it one minute later, with the commencement of migration of the nanoparticles being able to be seen clearly. The photograph at bottom left is after 10 minutes, with migration having progressed further, and that at bottom right is after one hour, with phase transfer being virtually complete.

The method described here is a general method of transferring gold and palladium nanoparticles with high efficiency from an organic solvent (in this case toluene) into water.

This method offers at least three advantages:

The first is that it replaces the hydrosol synthesis methods which require high dilutions and time-consuming dialysis purification processes.

Secondly, syntheses in organic solvents give high concentrations of nanoparticles having a monodispersity which is significantly better than that of particles formed in water; the method described here makes it possible for researchers whose experiments are based on aqueous solutions to obtain such particles.

Thirdly, since the transfer of the nanoparticles from the organic phase occurs without precipitate formation, it is possible to recover the expensive ammonium salts.

Furthermore, the water-dispersible metallic nanoparticles can be isolated as solids, which is important when highly concentrated solutions of the particles are required, e.g. in applications in the field of colloidal crystals.

The expected strong affinity of the DMAP-stabilized particles to negatively charged substrates as are customarily used in heterogeneous catalysis is likewise deserving of further examination.

According to a further, very wide-ranging aspect of the present invention, the inorganic, in particular aqueous solution as has been obtained by the above-described phase transfer process can advantageously also be used quite generally to recover nanoparticles used as homogeneous catalyst in a liquid after the catalyzed reaction. For example, gold nanoparticles are introduced as catalyst into a reaction mixture, after which the chemical reaction which is to be catalyzed by the gold nanoparticles is carried out. The catalyst, i.e. in this case the gold nanoparticles, can once again be removed according to the invention from the reaction mixture:

This is achieved by addition of one of the substances having the abovementioned, generic formula, i.e., for example, by means of 4-dimethylaminopyridine, preferably in solution in water.

As described above, this substance brings about the migration of the catalyst into the water. The water which now contains the nanoparticles can then be taken from the reaction zone. This gives the advantage that it is possible to achieve a catalytic efficiency of the catalyst which is many times as high as when the catalyst is, for instance, bound to Ceolite or carbon molecules, as is the case in the prior art. This step change in efficiency is brought about by a large increase in the catalytically active surface area for a constant number of catalyst molecules, because the catalyst particles are dispersed homogeneously in the reaction mixture and virtually all of their surface is available for the catalytic reaction. For this reason, much less catalyst is required for the same effect, which drastically reduces the costs, especially since noble metal nanoparticles are very expensive. It may also be remarked that in catalysis processes of the prior art in which, for insatnce, Ceolite is used as a catalyst support, a high proportion of potentially active catalyst surface is lost as a result of a substantial part of the catalyst remaining inactive in the interior of the support molecule because it does not have an exposed surface which can act catalytically.

A further advantage of the homogeneous catalysis process presented here is that the catalyst can be recovered to an extent of almost 100% after the reaction is complete, by exploiting the abovementioned inventive principle. In addition, this recycling of the catalyst can be carried out in a simple manner. This, too, contributes to a considerable reduction in costs.

A process variant according to the invention provides a transfer process for nanoparticles from inorganic, in particular aqueous solution into organic solution. In such a case, for example to obtain pure nanoparticles in the organic solution, the nanoparticles can, as described above, be selectively separated off by transferring them into water, as has been proposed in the first main aspect of the invention. The organic solvent “contaminated” with the by-products is then present in isolated form and can be disposed of or passed to another use. This is followed by the two steps described below, namely removal of the water and addition of fresh, uncontaminated organic solvent to the nanoparticles.

This variant comprises essentially the two steps:

a.) removal of part of the inorganic solvent to obtain the nanoparticles with a reduced content of inorganic solvent,

b.) addition of organic solvent to the nanoparticles.

These essential process steps can be used, for example, for purified reuse of the nanoparticles in fresh organic solution after such nanoparticles have been prepared in organic solutions and, in the process, undesirable by-products have also been formed in addition to the nanoparticles.

In a further embodiment of the teachings of the present invention disclosed here, the following 3 different types of catalysis, which are known from the prior art, can be improved by employing the inventive step of phase transfer as part of the catalytic process, The 3 types are as follows:
1. homogenous catalysis,
2. heterogeneous catalysis, and
3. mixed-phase catalysis.

As regards homogeneous catalysis:

The term homogeneous catalysis is used to describe a catalytic reaction in which the catalyst, in this case the colloids or nanoparticles, is dispersed in the reaction solution. This has the advantage that the entire surface of the nanoparticles is available to the starting material in the reaction solution. The reaction can then take place on or in the vicinity of the particle surface. The reaction products are therefore present in the same solution as the nanoparticles. This is a disadvantage of homogeneous catalysis carried out in the manner of the prior art, because nanoparticles cannot be removed from the solution in a simple fashion using known separation techniques, e.g. filtration. The present invention provides two alternatives:
a) the nanoparticles present in an organic solvent can be used as homogeneous catalysts in the organic solvents. After the reaction has taken place, the nanoparticles can then be removed from the solution using the phase transfer process of the invention.
b) nanoparticles present in an organic solvent can firstly be transferred into water, with or without a certain alcohol content, using the phase transfer process of the invention. The nanoparticles can then be used for homogeneous catalysis in such a water-soluble solvent. The particles transferred into the aqueous solution also have improved properties compared to particles produced in water; for example, they require no cocatalyst in the solution.

Regarding heterogeneous catalysis:

As described above, the main disadvantage of homogeneous catalysis is the fact that it is difficult to separate the catalyst from the reaction mixture (in order to recycle or purify the product). However, if the catalyst is immobilized on a larger object having a dimension greater than 100 nanometers, then the separation is considerably simpler. Supports known from the prior art have particle sizes in the micron range. The present invention can improve heterogeneous catalysis in the following way:

Nanoparticles synthesized in organic solvents can be transferred into water using the phase transfer process of the invention. Addition of a support compound which is chosen so that it has an affinity for the phase-transferred nanoparticles to the solution in which the nanoparticles are present results in the particles being bound to the support compound. The support compound can then be washed and/or made ready in a normal manner for use in the catalytic reaction, as is known from the prior art. After the catalytic reaction is complete, the nanoparticles adhering to the supports can then be recovered from the reaction mixture using known techniques for recycling or separation.

Regarding mixed-phases catalysis:

Alternatively, the catalytic reaction can also take place when different phases are mixed, with the nanoparticles being present as catalyst in one of these. Here, “phase” is 1 or more of: solids, gas or hydrophilic or hydrophobic liquids. If 2 of these phases are mixed, they separate in time. Nanoparticles can then be used as catalyst as described above, with the phase transfer process of the invention being able to be used in 3 different ways:
1. for separating off the catalyst after the reaction, for example into a mixture of hydrophobic and hydrophilic liquid, or
2. using phase transfer to form a solid-state catalyst which is then used, for example, in a solid/gas mixture, or
3. to form water-soluble nanoparticles which can then react at the interface to another phase, for example at the interface between hydrophilic liquid and solid or at the interface between hydrophobic and hydrophilic liquid in an appropriate mixture.

Mixed forms of all 3 phases, viz. solid, liquid and gas, are also possible in a corresponding way.

Although the present invention has been described above for a preferred example, it is not restricted thereto but can be modified in a variety of ways. In particular, the quantitative data provided are provided only by way of example and do not restrict the scope of the invention as defined in the claims.

For example, the MM component used in the phase transfer process of the invention can be added not in aqueous solution (with or without a proportion of alcohol) but also in isolated, undissolved form. The addition can be carried out either directly to the starting solution, for instance as a third phase in powder or slurry form, or after addition of a predetermined amount of target solution.

1-86. (canceled)

87. A method of transferring inorganic colloid particles from an organic phase into an aqueous or alcoholic phase, immiscible with the organic phase, said method using a phase transfer catalyst which comprises a hydrophobic component Y, a hydrophillic component X and an organic component Z, and concatenating the component X and Y, wherein the hydrophobic component Y comprises a weakly basic group, the hydrophillic component X comprises a strong basic, tertiary amino group and the groups are in conjugation via the organic component Z.

88. A method of transferring inorganic colloid particles from an organic phase into an aqueous or alcoholic phase, immiscible with the organic phase, said method using a phase transfer catalyst which comprises a hydrophobic component Y, a hydrophillic component X and an organic component Z, and concatenating the components X and Y, the hydrophobic component Y comprising a thiol group and the hydrophillic component X comprising a carboxylic group.

89. A method of transferring inorganic colloid particles from an organic phase into an aqueous or alcoholic phase, immiscible with the organic phase, said method using a phase transfer catalyst which comprises a hydrophobic component Y, a hydrophillic component X and an organic component Z, and concatenating the component X and Y, said transfer phase catalyst being mercaptopropyletrimethoxysilane.

90. The method of claim 87, wherein said phase transfer catalyst is 4-dimethylaminopyridine (DMAP).

91. The method according to claim 88, wherein said phase transfer catalyst is mercaptoundecanoic acid (MUA).

92. The method according to claim 87, wherein the ratio of the number of surface atoms of a colloid particle to the number of phase transfer catalyst molecules bound thereto is in a range from 0.1 to 10.

93. The method according to claim 88, wherein the ratio of the number of surface atoms of a colloid particle to the number of phase transfer catalyst molecules bound thereto is in a range from 0.1 to 10.

94. The method according to claim 89, wherein the ratio of the number of surface atoms of a colloid particle to the number of phase transfer catalyst molecules bound thereto is in a range from 0.1 to 10.

95. The method according to claim 92, wherein said ratio is about 1.

96. The method according to claim 93, wherein said ratio is about 1.

97. The method according to claim 94, wherein said ratio is about 1.

98. The method according to claim 87, wherein said colloid particles are at least one member of the group consisting of metal colloids, metal oxide colloids, and metal alloy colloids.

99. The method according to claim 88, wherein said colloid particles are at least one member of the group consisting of metal colloids, metal oxide colloids, and metal alloy colloids.

100. The method according to claim 89, wherein said colloid particles are at least one member of the group consisting of metal colloids, metal oxide colloids, and metal alloy colloids.

101. The method according to claim 98, wherein said metal is at least one member of the group consisting of gold, silver, iridium, platinum, palladium, nickel, iron, rhodium and ruthenium.

102. The method according to claim 99, wherein said metal is at least one member of the group consisting of gold, silver, iridium, platinum, palladium, nickel, iron, rhodium and ruthenium.

103. The method according to claim 100, wherein said metal is at least one member of the group consisting of gold, silver, iridium, platinum, palladium, nickel, iron, rhodium and ruthenium.

104. The method according to claim 98, wherein said metal oxide is at least one member of the group consisting of iron oxide, zinc oxide, titanium dioxide and tin oxide.

105. The method according to claim 99, wherein said metal oxide is at least one member of the group consisting of iron oxide, zinc oxide, titanium dioxide and tin oxide.

106. The method according to claim 100, wherein said metal oxide is at least one member of the group consisting of iron oxide, zinc oxide, titanium dioxide and tin oxide.

107. The method according to claim 87, wherein said colloid particles are semiconductor nanoparticles.

108. The method according to claim 88, wherein said colloid particles are semiconductor nanoparticles.

109. The method according to claim 89, wherein said colloid particles are semiconductor nanoparticles.

110. The method according to claim 87, wherein said colloid particles are inorganic nanoparticles which comprise rare earth elements.

111. The method according to claim 88, wherein said colloid particles are inorganic nanoparticles which comprise rare earth elements.

112. The method according to claim 89, wherein said colloid particles are inorganic nanoparticles which comprise rare earth elements.

113. The method according to claim 87, wherein said aqueous phase comprises water soluble components.

114. The method according to claim 88, wherein said aqueous phase comprises water soluble components.

115. The method according to claim 89, wherein said aqueous phase comprises water soluble components.

116. The method according to claim 1 13, wherein said aqueous phase comprises alcohols.

117. The method according to claim 1 14, wherein said aqueous phase comprises alcohols.

118. The method according to claim 115, wherein said aqueous phase comprises alcohols.

119. The method according to claim 87, wherein after said phase transfer has completed, said aqueous or alcoholic phase is separated from said organic phase.

120. The method according to claim 88, wherein after said phase transfer has completed, said aqueous or alcoholic phase is separated from said organic phase.

121. The method according to claim 89, wherein after said phase transfer has completed, said aqueous or alcoholic phase is separated from said organic phase.

122. An aqueous or alcoholic phase obtainable by the method according to claim 87.

123. An aqueous or alcoholic phase obtainable by the method according to claim 88.

124. An aqueous or alcoholic phase obtainable by the method according to claim 89.

125. A method for selectively coating surfaces of macroscopic bodies, comprising the step of using an aqueous or alcoholic phase obtainable by transferring inorganic colloid particles from an organic phase into an aqueous or alcoholic phase, immiscible with said organic phase, by using a phase transfer catalyst which comprises a hydrophobic component Y, a hydrophillic component X and an organic molecule Z, and concatenating said components X and Y, one condition being present from the group consisting of:
(1) said hydrophobic component Y comprising a weakly basic group, said hydrophillic component X comprising a strongly basic, tertiary amino group, and said groups being in conjugation via said organic component Z,
(2) said hydrophobic component Y comprising a thiol group and said hydrophillic component X comprising a carboxylic group, and
(3) said phase transfer catalyst being mercaptopropyletrimethoxysilane.

126. A method for selectively coating carrier particles, comprising the step of using an aqueous or alcoholic phase obtainable by transferring inorganic colloid particles from an organic phase into an aqueous or alcoholic phase, immiscible with said organic phase, by using a phase transfer catalyst which comprises a hydrophobic component Y, a hydrophillic component X and an organic molecule Z, and concatenating said components X and Y one condition being present from the group consisting of:
(1) said hydrophobic component Y comprising a weakly basic group, said hydrophillic component X comprising a strongly basic, tertiary amino group, and said groups being in conjugation via said organic component Z,
(2) said hydrophobic component Y comprising a thiol group and said hydrophillic component X comprising a carboxylic group, and
(3) said phase transfer catalyst being mercaptopropyletrimethoxysilane.

127. A method for marking biologically derived molecules, comprising the step of using an aqueous or alcoholic phase obtainable by transferring inorganic colloid particles, from an organic phase into an aqueous or alcoholic phase, immiscible with said organic phase, by using a phase transfer catalyst which comprises a hydrophobic component Y, a hydrophillic component X and an organic molecule Z, and concatenating said components X and Y one condition being present from the group consisting of:
(1) said hydrophobic component Y comprising a weakly basic group, said hydrophillic component X comprising a strongly basic, tertiary amino group, and said groups being in conjugation via said organic component Z,
(2) said hydrophobic component Y comprising a thiol group and said hydrophillic component X comprising a carboxylic group, and
(3) said phase transfer catalyst being mercaptopropyletrimethoxysilane.

128. A paint, comprising a dye solution having an aqueous or alcoholic phase produced by transferring inorganic colloid particles from an organic phase into an aqueous or alcoholic phase, immiscible with said organic phase, by using a phase transfer catalyst which comprises a hydrophobic component Y, a hydrophillic component X and an organic molecule Z, and concatenating said components X and Y one condition being present from the group consisting of:
(1) said hydrophobic component Y comprising a weakly basic group, said hydrophillic component X comprising a strongly basic, tertiary amino group, and said groups being in conjugation via said organic component Z,
(2) said hydrophobic component Y comprising a thiol group and said hydrophillic component X comprising a carboxylic group, and
(3) said phase transfer catalyst being mercaptopropyletrimethoxysilane.

129. A printing ink, comprising a dye solution having an aqueous or alcoholic phase produced by transferring inorganic colloid particles from an organic phase into an aqueous or alcoholic phase, immiscible with said organic phase, by using a phase transfer catalyst which comprises a hydrophobic component Y, a hydrophillic component X and an organic molecule Z, and concatenating said components X and Y one condition being present from the group consisting of:
(1) said hydrophobic component y comprising a weakly basic group, said hydrophillic component X comprising a strongly basic, tertiary amino group, and said groups being in conjugation via said organic component Z,
(2) said hydrophobic component Y comprising a thiol group and said hydrophillic component X comprising a carboxylic group, and
(3) said phase transfer catalyst being mercaptopropyletrimethoxysilane.

130. A varnish, comprising a dye solution having an aqueous or alcoholic phase produced by transferring inorganic colloid particles from an organic phase into an aqueous or alcoholic phase, immiscible with said organic phase, by using a phase transfer catalyst which comprises a hydrophobic component Y, a hydrophillic component X and an organic molecule Z, and concatenating said components x and y one condition being present from the group consisting of:
(1) said hydrophobic component Y comprising a weakly basic group, said hydrophillic component X comprising a strongly basic, tertiary amino group, and said groups being in conjugation via said organic component Z,
(2) said hydrophobic component Y comprising a thiol group and said hydrophillic component X comprising a carboxylic group, and
(3) said phase transfer catalyst being mercaptopropyletrimethoxysilane.

131. An article, having a coating formed of one of a varnish, a paint and an ink produced by using an aqueous or alcoholic phase obtainable by transferring inorganic colloid particles from an organic phase into an aqueous or alcoholic phase, immiscible with said organic phase, by using a phase transfer catalyst which comprises a hydrophobic component Y, a hydrophillic component X and an organic molecule Z, and concatenating said components X and Y one condition being present from the group consisting of:
(1) said hydrophobic component Y comprising a weakly basic group, said hydrophillic component X comprising a strongly basic, tertiary amino group, and said groups being in conjugation via said organic component Z,
(2) said hydrophobic component Y comprising a thiol group and said hydrophillic component X comprising a carboxylic group, and
(3) said phase transfer catalyst being mercaptopropyletrimethoxysilane.

132. A method of homogeneous, heterogeneous, or mixed-phase catalysis, comprising the step of utilizing an aqueous or alcoholic phase obtainable by transferring inorganic colloid particles from an organic phase into an aqueous or alcoholic phase, immiscible with said organic phase, by using a phase transfer catalyst which comprises a hydrophobic component Y, a hydrophillic component X and an organic molecule Z, and concatenating said components X and Y one condition being present from the group consisting of:
(1) said hydrophobic component Y comprising a weakly basic group, said hydrophillic component X comprising a strongly basic, tertiary amino group, and said groups being in conjugation via said organic component Z,
(2) said hydrophobic component Y comprising a thiol group and said hydrophillic component X comprising a carboxylic group, and
(3) said phase transfer catalyst being mercaptopropyletrimethoxysilane.

133. The method of claim 125, further comprising the step of removing the solvent from said aqueous or alcoholic phase so as to obtain one of a powder and a slurry comprising a powder.

134. The method of claim 126, further comprising the step of removing the solvent from said aqueous or alcoholic phase so as to obtain one of a powder and a slurry comprising a powder.

135. The method of claim 127, further comprising the step of removing the solvent from said aqueous or alcoholic phase so as to obtain one of a powder and a slurry comprising a powder.

136. The method according to claim 133, further including washing the powder or slurry with a solvent for removing said phase transfer catalyst.

137. The method according to claim 134, further including washing the powder or slurry with a solvent for removing said phase transfer catalyst.

138. The method according to claim 135, further including washing the powder or slurry with a solvent for removing said phase transfer catalyst.

139. The paint according to claim 128, wherein the aqueous or alcoholic phase has a solvent removed so that one of a powder and a slurry comprising a powder is obtainable.

140. A printing ink according to claim 129, wherein the aqueous or alcoholic phase has a solvent removed so that one of a powder and a slurry comprising a powder is obtainable.

141. A varnish according to claim 130, wherein the aqueous or alcoholic phase has a solvent removed so that one of a powder and a slurry comprising a powder is obtainable.

142. The method according to claim 87, wherein said colloid particles are comprised of gold colloids.

143. The method of claim 87, wherein said phase transfer catalyst is DMAP.

144. Aqueous phase obtainable by the method according to claim 142.

145. Aqueous phase obtained by the method according to claim 143.
